(19) United States
(12) Patent Application Publication
(10) Pub. No.: US 2015/0020944 A1
(43) Pub. Date: Jan. 22, 2015

(54) PNEUMATIC TIRE HAVING A SINGLE CARCASS PLY REINFORCED WITH POLYESTER CORDS

(71) Applicant: The Goodyear Tire & Rubber Company, Akron, OH (US)

(72) Inventors: Douglas Andrew Till, Akron, OH (US); Daniel Ray Beha, Akron, OH (US); Kelly Sue King, Wadsworth, OH (US); Christopher John Weiler, Canal Fulton, OH (US)

(73) Assignee: The Goodyear Tire & Rubber Company, Akron, OH (US)

(21) Appl. No.: 13/944,086

(22) Filed: Jul. 17, 2013

(51) Int. Cl. B60C 15/04; B60C 15/06; B60C 9/00; B60C 15/00

(52) U.S. Cl. CPC B60C 15/04; B60C 15/0036; B60C 15/0603; B60C 15/0632; B60C 15/0635; B60C 9/0042; B60C 2015/009; B60C 2015/042; B60C 2015/0614
USPC 152/541; 152/539; 152/542

(57) ABSTRACT

A pneumatic tire includes a pair of axially spaced apart annular bead cores, each bead core comprising a plurality of metal wraps, each bead core having a radial cross-sectional shape; and a single carcass ply reinforced with polyester cords, the single carcass ply being folded about each bead core, the carcass ply having a main portion that extends between the bead cores and turnup portions that are folded around the bead cores, the polyester cords having a construction of 2000-2000 dtex/½ 8-10/8-10 tpi and 20-30 epi.

### FIELD OF THE PRESENT INVENTION

The present invention relates to a pneumatic tire having a single carcass reinforced with high strength metallic cords and a high ending turnup and a locked bead construction.

### BACKGROUND OF THE INVENTION

One conventional pneumatic tire includes a carcass ply having a main portion that extends between both bead cores of the tire and turnup portions that are anchored around each bead core. The radially outer edges of the turnup portions of the carcass ply are disposed radially outward of the bead cores a minimal distance and are in contact with the main portion of the carcass ply. Suitable elastomeric materials surround the bead core, carcass ply and other elastomeric components to complete the bead portion of the tire. A clamping member includes a strip of side-by-side cords of a heat shrinkable material embedded in a suitable elastomeric substance having a permanent thermal shrinkage of at least 2 percent. This strip of cords is extended from a location radially and axially inward of the bead core to a location radially outward of the bead core with no filler strip or apex disposed between the main portion and turnup portion of the carcass ply. The heat shrinkable material may be 1260/2 Nylon 6,6 having a permanent thermal shrinkage of about 4 percent. It is a continual overriding goal to simplify the construction and reduce the expense of building tires, yet improve the durability, handling, rolling resistance, and other properties of the pneumatic tires.

Another conventional pneumatic tire has a pair of axially spaced annular bead cores and a single carcass ply which is folded about each bead core. Each bead core includes a plurality of wraps of a single metallic filament. The single carcass ply is reinforced with parallel metallic cords composed of at least one filament having a tensile strength of at least (−2000×D+4400 MPa)×95%, where D is the filament diameter in millimeters. The single carcass ply is folded about each bead core. The single carcass ply has a main portion that extends between the bead cores and turnup portions that are folded around the bead cores. A radially outer edge of each turnup portion is in contact with the main portion of the carcass ply and extends to an end point 0.5 inches (12.7 mm) to 4.0 inches (101.6 mm) radially outward of the bead core, as measured along the main portion of the carcass ply of the tire. No bead apex or filler is present between the carcass turnup and the main portion of the carcass ply. A toe guard associated with each bead has each end (first and second) of the toe guard being disposed directly adjacent to the carcass ply. One (the first) end is located on the axially inner side of the main portion of the carcass ply at a location about 0.4 to 3.5 inch(s) (10 mm to 89 mm) radially outward of the bead core as measured along the main portion of the carcass ply. The other, or second, end of the toe guard is located at a point ranging from substantially the axially outermost point of the bead core to a location about 3.5 inches (89 mm) radially outward of the bead core as measured along the turnup portion of the carcass ply. The first end and the second end of the toe guard is a shorter radial distance from said bead core than the end point of the turnup radial portion of the carcass ply. The respective turnup portion of the carcass ply is directly adjacent to both the toe guard and the bead core.

### SUMMARY OF THE INVENTION

A pneumatic tire in accordance with the present invention includes a pair of axially spaced apart annular bead cores, each bead core comprising a plurality of metal wraps, each bead core having a radial cross-sectional shape; and a single carcass ply reinforced with polyester cords, the single carcass ply being folded about each bead core, the carcass ply having a main portion that extends between the bead cores and turnup portions that are folded around the bead cores, the polyester cords having a construction of 2000-2000 dtex/½ 8-10/8-10 tpi and 20-30 epi.

According to another aspect of the pneumatic tire, the polyester cords have a construction of 2200 dtex/½ 8.5/8.5 tpi and 26 epi.

According to still another aspect of the pneumatic tire, an apex stiffens the areas adjacent the bead cores.

According to yet another aspect of the pneumatic tire, a chipper stiffens the areas adjacent the bead cores.

According to still another aspect of the pneumatic tire, a flipper stiffens the areas adjacent the bead cores.

According to yet another aspect of the pneumatic tire, the bead cord has a radial cross-sectional shape selected from the group consisting of substantially pentagonal, hexagonal, rectangular, and circular.

According to still another aspect of the pneumatic tire, the turnup portions are in contact with the main portion and extend to an end point 0.5 inches (12.7 mm) to 3.5 inches (88.9 mm) radially outward of the bead core, as measured along the main portion of the single carcass ply.

According to yet another aspect of the pneumatic tire, a toe guard is disposed on an axially inner side of the main portion of the single carcass ply at a location about 0.4 inches (10.16 mm) to 2.0 inches (50.8 mm) radially outward of the bead core.

According to still another aspect of the pneumatic tire, an end of the toe guard is disposed at a point ranging from substantially the axially outermost point of the bead core to a location about 2.0 inches (50.8 mm) radially outward of the bead core as measured along the turnup portion of the single carcass ply.

### BRIEF DESCRIPTION OF THE DRAWINGS

The invention will be described by way of example and with reference to the accompanying drawings in which:

FIG. 1 is a partial schematic cross-sectional view of a pneumatic tire in accordance with the present invention; and

FIG. 2 is a schematic cross-sectional view of the bead portion of the pneumatic tire of FIG. 1 mounted upon a rim.

### DEFINITIONS

The following definitions are controlling for the present invention.

“Apex” means an elastomeric filler located radially above the bead core and between the plies and the turnup ply.

“Annular” means formed like a ring.

“Aspect ratio” means the ratio of its section height to its section width.

“Asymmetric tread” means a tread that has a tread pattern not symmetrical about the centerplane or equatorial plane EP of the tire.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.“Axial” and “axially” are used herein to refer to lines or directions that are parallel to the axis of rotation of the tire.

### DETAILED DESCRIPTION OF EXAMPLE OF THE PRESENT INVENTION

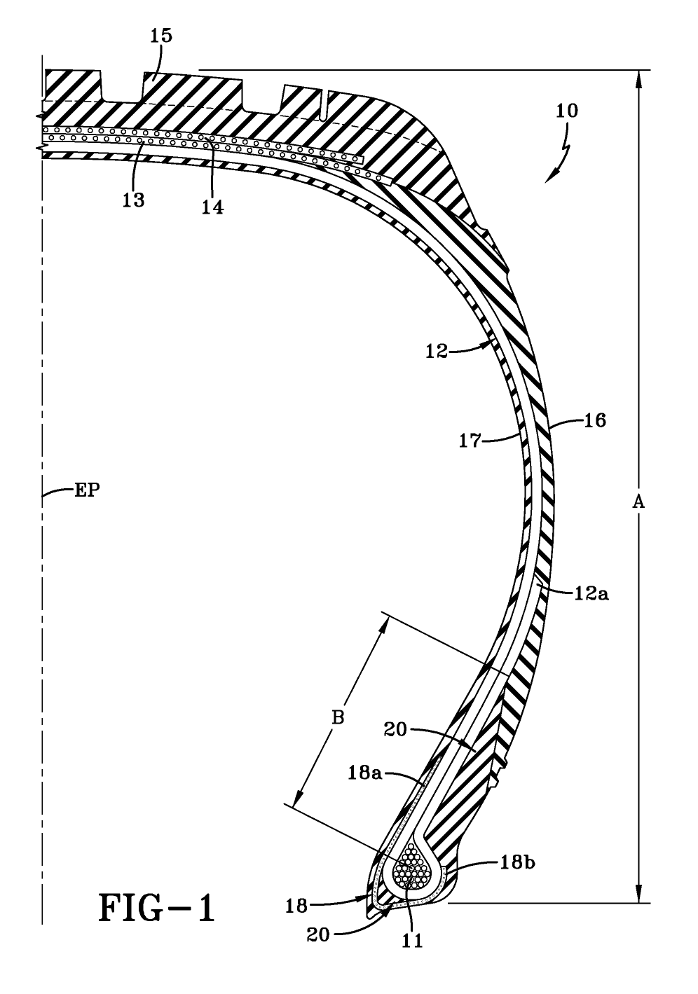

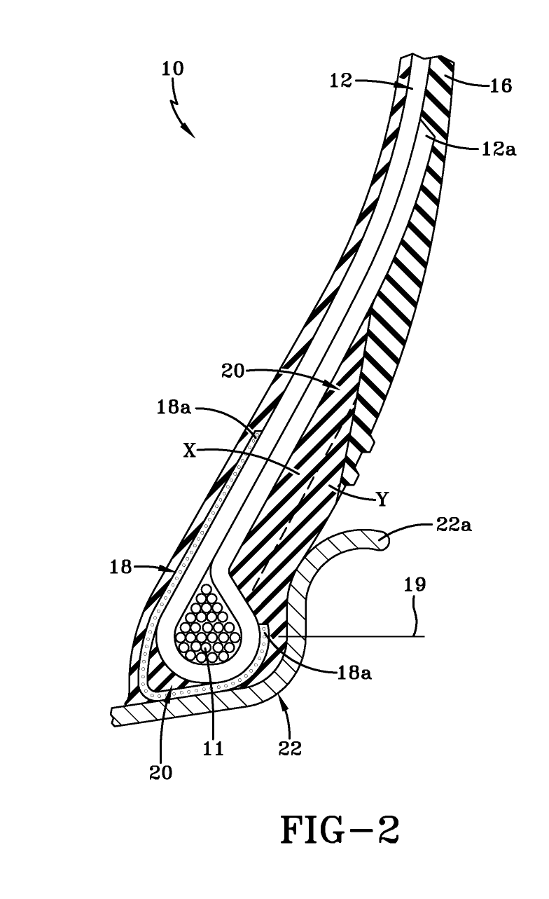

Referring now to FIGS. 1 and 2, there is shown a cross-sectional view of a pneumatic tire 10 for use with the present invention and an enlarged fragmentary view of a bead portion and lower sidewall of the pneumatic tire 10 mounted upon a rim.

The pneumatic tire 10 may have a pair of bead cores 11 (only one shown), each comprising a plurality of metallic filaments. The pneumatic tire 10 may have a single carcass ply 12 extending between the bead cores 11 and a turnup portion anchored around each bead core 11. A belt structure may have at least two belts 13, 14 disposed radially outward of the main portion of the carcass ply and a ground engaging tread portion 15 disposed radially outward of the belt structure. Sidewall portions 16 (one shown) may extend radially inward from the tread portion 15 to the bead portions. On the axially inner side of the carcass ply 12, an air-impermeable innerliner 17 may be used. The innerliner 17 may have a layer or layers of elastomer or other material that form an inside surface of the pneumatic tire 10 and contain the inflating fluid, such as air, within the pneumatic tire. Additional barriers, reinforcement strips, or gum strips (not shown) may be placed at suitable locations between the innerliner 17 and main portion of the carcass ply 12 to avoid penetration of rubber through the carcass ply, especially during curing of the pneumatic tire 10.

In accordance with the present invention, the pneumatic tire 10 may have a single ply carcass construction (e.g., monopoly) reinforced with parallel polyester cords. The carcass reinforcing ply 12 may include a high tenacity polyester cord of the construction 2000-2400 dtex/½ 8-10/8-10 turns per inch (tpi) and between 20 and 30 ends per inch (epi). This polyester construction demonstrates improved tenacity, modulus, and fatigue properties over conventional monopoly polyester constructions. One example polyester construction may be 2200 dtex/ 1/2 8.5/8.5 tpi and 26 epi.

Conventionally, SUV/MPV tires include two plies of 1100/½ polyester or 1670/½ polyester. Current monoply constructions with polyester materials have been unable to meet design and performance requirements. A polyester yarn with 4% higher tenacity may be combined with a construction of 2200/½, 8.5×8.5 tpi, 26 epi and additional stiffness in the lower sidewall and bead area (e.g., apex, chipper, flipper, and/or insert) in accordance with the present invention may meet such requirements. Additionally, tire weight and cost may be reduced while still improving production efficiency and manufacturability.

Further, this unique high tenacity polyester monopoly construction may provide an improved alternative to current rayon carcass ply constructions because the polyester construction may have equivalent functional properties at a lower cost and rolling resistance compared to rayon. The high tenacity polyester construction may improve mileage and durability while maintaining the benefits of such high linear density constructions. However, in order to facilitate high temperature interfacial strength (i.e., between the surface of the polyester cord(s) and an adhesive or elastomer), the surface reactivity of the polyester filaments may be increased. For example, to achieve this, a high epoxy content spin finish/coating may be used as a thermal barrier to degradation. Alternatively, the polyester filaments may be dipped in an adhesive with a high epoxy content. Below are two tables comparing an exemplary high twist 8/8 polyester construction with two other polyester constructions. The high tenacity polyester cord construction of the present invention may have improved fatigue properties even over the exemplary 8/8 twist cord of the below tables.

The direction of twist refers to the direction of slope of the spirals of a filament, yarn, or cord when it is held vertically. If the slope of the spirals conform in direction to the slope of the letter “S”, then the twist is called “S” or “left hand”. If the slope of the spirals conform in direction to the slope of the letter “Z”, then the twist is called “Z” or “right hand”. An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. “Dtex” is understood to mean the weight in grams of 10,000 meters of a yarn before the yarn has a twist imparted thereto.

TABLE 1

| Material | PET | PET | PET |
|---|---|---|---|
| Dtex | 2200 | 2200 | 2200 |
| Construction | 2 | 2 | 2 |
| Twist Z | 4.5 | 6 | 8 |
| Twist S | 4.5 | 6 | 8 |
| Fatigue test #1: | | | |
| Brk. Strength Original (N) | 266.3 | 309.3 | 283.7 |
| Brk. Strength After 8 h (N) | 151.9 | 163.4 | 207.6 |
| Brk. Strength Retained (%) | 57.0 | 52.8 | 73.2 |
| Fatigue test #2: | | | |
| Brk. Strength Original (N) | 306.3 | 305.4 | 290.6 |
| Brk. Strength After 8 h (N) | 0 | 107.4 | 271.8 |
| Brk. Strength After 24 h (N) | 0 | 0 | 255.3 |
| Brk. Strength Retained (%) | 0 | 35.2 | 93.5 |
| Brk. Strength Retained (%) | 0 | 0 | 87.9 |

TABLE 2

| Material | PET | PET | PET |
|---|---|---|---|
| Dtex | 2200 | 2200 | 2200 |
| Construction | 2 | 2 | 2 |
| Twist Z | 4.5 | 6 | 8 |
| Twist S | 4.5 | 6 | 8 |
| Breaking Strength (N) | 311.1 | 301.7 | 277.4 |
| Elongation at break (%) | 15.4 | 15.6 | 15.6 |
| Lase @ 5% (N) | 93.1 | 88.3 | 80.5 |
| Work of Rupture (Nm) | 6.1 | 5.9 | 5.3 |
| Dry Tenacity (cN/Tex) | 58 | 55 | 49 |
| Total Shrinkage (%) | 1.1 | 1.3 | 1.6 |
| Permanent Shrink. (%) | 1.1 | 1.1 | 1.3 |
| Linear Density cond. (dTex) | 5346.1 | 5473.1 | 5698.7 |
| Linear Density dry (dTex) | 5322.4 | 5448.1 | 5671.5 |
| Gauge | 0.740 | 0.790 | 0.800 |
| Cable Twist Direction | S | S | S |
| Cable Twist (Tpi) | 4.49 | 5.87 | 7.87 |
| Ply Twist Direction | Z | Z | Z |
| Ply Twist (Tpi) | 4.50 | 6.12 | 8.78 |

The carcass reinforcing ply 12 of the example tire 10 is typically a multiple cord-reinforced component where the cords are embedded in a rubber composition which is usually referred to as a ply coat. The ply coat rubber composition is conventionally applied by calendering the rubber onto the multiplicity of cords as they pass over, around, and through relatively large, heated, rotating, metal cylindrical rolls. Such ply components 12 of a tire 10, as well as the calendering method of applying the rubber composition ply coat, are known to those having skill in such art.

Cords of various compositions may be used for a carcass ply 12, such as, for example, but not intended to be limiting, polyester, rayon, aramid and nylon. Many such cords and their construction, whether monofilament or as twisted filaments, are known to those having skill in such art. In particular, polyester cords have been desirable for use in a monopoly 12 of SUV/MPV tires because of their excellent properties, such as improved rolling resistance, and relatively low cost. Further, treatment of polyester cords subsequent to twisting of the polyester yarns into cord provides for improved adhesion between the polyester and ply coat in a pneumatic tire 10.

The treatment of the polyester cords may comprise treating the cord after twist of the yarn with an aqueous emulsion comprising a polyepoxide, followed by treating the cord with an aqueous RFL emulsion comprising a resorcinol-formaldehyde resin, a styrene-butadiene copolymer latex, a vinylpyridine-styrene-butadiene terpolymer latex, and a blocked isocyanate. A polyester cord used in a carcass ply 12 may be made from any polyester fiber suitable for use in a tire. Polyester cord yarns are typically produced as multi-filament bundles by extrusion of the filaments from a polymer melt. Polyester cord is produced by drawing polyester fiber into yarns comprising a plurality of the filaments, followed by twisting a plurality of these yarns into a cord. Such yarns may be treated with a spin-finish to protect the filaments from fretting against each other and against machine equipment to ensure good mechanical properties.

In some cases, the yarn may be top-coated with a so-called adhesion activator prior to twisting the yarn into cord. The polyester may also be treated with an RFL (Resorcinol-Formaldehyde-Latex) dip after twisting the yarn into cord. The adhesion activator, typically comprising a polyepoxide, serves to improve adhesion of the polyester cord to rubber compounds after it is dipped with an RFL dip. Such dips are not robust against long and high temperature cures in compounds that contain traces of humidity and amines which attack the cord filament skin and degrade the adhesive/cord interface. The typical sign of failure is a nude polyester cord showing only traces of adhesive left on it.

The polyepoxide may also be added after the polyester yarns are twisted into cords. The twisted cords are dipped in an aqueous dispersion of a polyepoxide, also referred to herein as an epoxy or epoxy compound. The polyester cord may be formed from yarns that have been treated with sizing or adhesives prior to twist. Thus, cords made using the adhesive activated yarns (i.e., yarns treated with adhesive prior to twist) may be subsequently treated as well.

As a polyepoxide, use may be made of reaction products between an aliphatic polyalcohol, such as glycerine, propylene glycol, ethylene glycol, hexane triol, sorbitol, trimethylol propane, 3-methylpentanetriol, poly(ethylene glycol), poly(propylene glycol), etc. and a halohydrine, such as epichlorohydrin, reaction products between an aromatic polyalcohol such as resorcinol, phenol, hydroquinoline, phloroglucinol bis(4-hydroxyphenyl)methane and a halohydrin, reaction products between a novolac type phenolic resin such as a novolac type phenolic resin, or a novolac type resorcinol resin and halohydrin. The polyepoxide may be derived from an ortho-cresol formaldehyde novolac resin.

The polyepoxide may be used as an aqueous dispersion of a fine particle polyepoxide. The polyepoxide may be present in the aqueous dispersion in a concentration range of from about 1 to about 5 percent by weight. Alternatively, the polyepoxide may be present in the aqueous dispersion in a concentration range of from about 1 to about 3 percent by weight.

In a first treatment step, dry polyester cord may dipped in the aqueous polyepoxide dispersion. The cord may dipped for a time sufficient to allow a dip pick up, or DPU, of between about 0.3 and 0.7 percent by weight of polyepoxide. Alternatively, the DPU is between about 0.4 and 0.6 percent by weight. The DPU is defined as the dipped cord weight (after drying or curing of the dipped cord) minus the undipped cord weight, then divided by the undipped cord weight.

The polyester cord may be treated in the aqueous polyepoxide dispersion in a continuous process by drawing the cord through a dispersion bath, or by soaking the cord in batch. After dipping in the polyepoxide dispersion, the cord is dried or cured to remove the excess water, using methods as are known in the art.

In a second treatment step, the polyepoxide treated polyester cord may dipped in a modified RFL liquid. The adhesive composition may be comprised of (1) resorcinol, (2) formaldehyde and (3) a styrene-butadiene rubber latex, (4) a vinylpyridine-styrene-butadiene terpolymer latex, and (5) a blocked isocyanate. The resorcinol reacts with formaldehyde to produce a resorcinol-formaldehyde reaction product. This reaction product may be the result of a condensation reaction between a phenol group on the resorcinol and the aldehyde group on the formaldehyde. Resorcinol resoles and resorcinol-phenol resoles, whether formed in situ within the latex or formed separately in aqueous solution, may be considerably superior to other condensation products in the adhesive mixture.

The resorcinol may be dissolved in water to which around 37 percent formaldehyde has been added together with a strong base such as sodium hydroxide. The strong base should generally constitute around 7.5 percent or less of the resorcinol, and the molar ratio of the formaldehyde to resorcinol should be in a range of from about 1.5 to about 2. The aqueous solution of the resole or condensation product or resin may be mixed with the styrene-butadiene latex and vinylpyridine-styrene-butadiene terpolymer latex. The resole or other mentioned condensation product or materials that form said condensation product should constitute from 5 to 40 parts and preferably around 10 to 28 parts by solids of the latex mixture. The condensation product forming the resole or resole type resin forming materials should preferably be partially reacted or reacted so as to be only partially soluble in water. Sufficient water is then preferably added to give around 12 percent to 18 percent by weight overall solids in the final dip. The weight ratio of the polymeric solids from the latex to the resorcinol/formaldehyde resin should be in a range of about 2 to about 6.

The RFL adhesive may also include a blocked isocyanate. About 1 to about 8 parts by weight of solids of blocked isocyanate may be added to the adhesive. The blocked isocyanate may be any suitable blocked isocyanate known to be used in RFL adhesive dips, including but not limited to caprolactam blocked methylene-bis-(4-phenylisocyanate), such as Grilbond-IL6 available from EMS American Grilon, Inc., and phenol formaldehyde blocked isocyanates.

As a blocked isocyanate, use may be made of reaction products between one or more isocyanates and one or more kinds of isocyanate blocking agents. The isocyanates may include monoisocyanates, such as phenyl isocyanate, dichlorophenyl isocyanate and naphthalene monoisocyanate, diisocyanate such as tolylene diisocyanate, dianisidine diisocyanate, hexamethylene diisocyanate, m-phenylene diisocyanate, tetramethylene diisocyante, alkylbenzene diisocyanate, m-xylene diisocyanate, cyclohexylmethane diisocyanate, 3,3-dimethoxyphenylmethane-4,4′-diisocyanate, 1-alkoxybenzene-2,4-diisocyanate, ethylene diisocyanate, propylene diisocyanate, cyclohexylene-1,2-diisocyanate, diphenylene diisocyanate, butylene-1,2-diisocyanate, diphenylmethane-4,4diisocyanate, diphenylethane diisocyanate, 1,5-naphthalene diisocyanate, etc., and triisocyanates such as triphenylmethane triisocyanate, diphenylmethane triisocyanate, etc.

The isocyanate-blocking agents may include phenols, cresol, resorcinol, tertiary alcohols, such as t-butanol and t-pentanol, aromatic amines, such as diphenylamine, diphenylnaphthylamine and xylidine, ethyleneimines, such as ethylene imine and propyleneimine, imides, such as succinic acid imide, and phthalimide, lactams such as butyrolactam, ureas, such as urea and diethylene urea, oximes, such as acetoxime, cyclohexanoxime, benzophenon oxime, and .alpha.-pyrolidon.

Polymers may be added in the form of a latex or otherwise. A vinylpyridine-styrene-butadiene terpolymer latex and styrene-butadiene rubber latex may be added to the RFL adhesive. The vinylpyridiene-styrene-butadiene terpolymer may be present in the RFL adhesive such that the solids weight of the vinylpyridiene-styrene-butadiene terpolymer is from about 50 percent to about 100 percent of the solids weight of the styrene-butadiene rubber; in other words, the weight ratio of vinylpyridiene-styrene-butadiene terpolymer to styrene-butadiene rubber may be from about 1 to about 2.

The polymer latex is typically prepared and then the partially condensed condensation product is added. However, the ingredients (the resorcinol and formaldehyde) may be added to the polymer latex in the uncondensed form and the entire condensation may then take place in situ. The latex tends to keep longer and be more stable if it is kept at an alkaline pH level.

The polyepoxide treated cord may be dipped for one to about three seconds in the RFL dip and dried at a temperature within the range of 120 degrees C. to 265 degrees C. for 0.5 to 4.0 minutes, and thereafter calendered into the rubber and cured therewith. The drying step utilized is typically carried out by passing the cord through 2 or more drying ovens which are maintained at progressively higher temperatures. For instance, the cord may be passed through a first drying oven which is maintained at a temperature of about 250 degrees F. (121 degrees C.) to about 300 degrees F. (149 degrees C.) and then passed through a second oven which is maintained at a temperature which is within the range of about 350 degrees F. (177 degrees C.) to about 500 degrees F. (260 degrees C.).

It should be appreciated that these temperatures are oven temperatures rather than the temperature of the cord being dried. The cord will preferably have a total residence time in the drying ovens within the range of about 1 minute to about 5 minutes. For example, a residence time of 30 seconds to 90 seconds in the first oven and 30 seconds to 90 seconds in the second oven may be employed.

After treatment of the polyester cord in the polyepoxide and RFL, the treated cord is incorporated into a ply layer with a rubber ply coat compound. Conventional compounding ingredients may be used in the preparation of the ply coat rubber composition. The ply coat, in the finished tire may be sulfur cured as a component of the tire. For example, the sulfur cured ply coat rubber composition may contain conventional additives, including reinforcing agents, fillers, peptizing agents, pigments, stearic acids, accelerators, sulfur-vulcanizing agents, antiozonants, antioxidants, processing oils, activators, initiators, plasticizers, waxes, pre-vulcanization inhibitors, extender oils, etc. Representative of conventional accelerators may be, for example, amines, guanidines, thioureas, thiols, thiurams, sulfenamides, dithiocarbamates and xanthates, which are typically added in amounts of from about 0.2 to about 3.0 phr. Representative of sulfur-vulcanizing agents include element sulfur (free sulfur) or sulfur donating vulcanizing agents, for example, an amine disulfide, polymeric polysulfide or sulfur olefin adducts. The amount of sulfur-vulcanizing agent will vary depending on the type of rubber and particular type of sulfur-vulcanizing agent but generally range from about 0.1 phr to about 3 phr with a range of from about 0.5 phr to about 2 phr being preferred.

Representative of the antidegradants which may be in the rubber composition include monophenols, bisphenols, thiobisphenols, polyphenols, hydroquinone derivatives, phosphites, phosphate blends, thioesters, naphthylamines, diphenol amines as well as other diaryl amine derivatives, para-phenylene diamines, quinolines and blended amines. Antidegradants are generally used in an amount ranging from about 0.1 phr to about 10.0 phr, with a range of from about 2 to 6 phr being preferred. Amine based antidegradants, however, are not preferred.

Representative of a peptizing agent that may be used is pentachlorophenol which may be used in an amount ranging from about 0.1 phr to 0.4 phr, with a range of from about 0.2 to 0.3 phr being preferred. Representative of processing oils which may be used in the rubber composition include aliphatic, naphthenic, and aromatic oils. The processing oils may be used in a conventional amount ranging from about 0 to about 30 phr, with a range of from about 5 to about 15 phr being preferred.

Initiators are generally used in a conventional amount ranging from about 1 to 4 phr, with a range of from about 2 to 3 phr being preferred. Accelerators may be used in a conventional amount. In cases where only a primary accelerator is used, the amounts may range from about 0.5 to about 2.0 phr. In cases where combinations of two or more accelerators are used, the primary accelerator may generally be used in amounts ranging from 0.5 to 1.5 phr and a secondary accelerator may be used in amounts ranging from about 0.1 to 0.5 phr.

Combinations of accelerators have been known to produce a synergistic effect. Suitable types of conventional accelerators are amines, disulfides, guanidines, thioureas, thiazoles, thiurams, sulfenamides, dithiocarbamates and xanthates. Preferably, the primary accelerator is a sulfenamide. If a secondary accelerator is used, it is preferably a guanidine, dithiocarbamate or thiuram compound.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A pneumatic tire comprising:
a pair of axially spaced apart annular bead cores, each bead core comprising a plurality of metal wraps, each bead core having a radial cross-sectional shape; and
a single carcass ply reinforced with polyester cords, the single carcass ply being folded about each bead core, the carcass ply having a main portion that extends between the bead cores and turnup portions that are folded around the bead cores, the polyester cords having a construction of 2000-2000 dtex/½ 8-10/8-10 tpi and 20-30 epi.

2. The pneumatic tire as set forth in claim 1 wherein the polyester cords have a construction of 2200 dtex/½ 8.5/8.5 tpi and 26 epi.

3. The pneumatic tire as set forth in claim 1 further including an apex for stiffening the areas adjacent the bead cores.

4. The pneumatic tire as set forth in claim 1 further including a chipper for stiffening the areas adjacent the bead cores.

5. The pneumatic tire as set forth in claim 1 further including a flipper for stiffening the areas adjacent the bead cores.

6. The pneumatic tire as set forth in claim 1 wherein the bead cord has a radial cross-sectional shape selected from the group consisting of substantially pentagonal, hexagonal, rectangular, and circular.

7. The pneumatic tire as set forth in claim 1 wherein the turnup portions are in contact with the main portion and extend to an end point 0.5 inches (12.7 mm) to 3.5 inches (88.9 mm) radially outward of the bead core, as measured along the main portion of the single carcass ply.

8. The pneumatic tire as set forth in claim 1 further including a toe guard disposed on an axially inner side of the main portion of the single carcass ply at a location about 0.4 inches (10.16 mm) to 2.0 inches (50.8 mm) radially outward of the bead core.

9. The pneumatic tire as set forth in claim 8 wherein an end of the toe guard is disposed at a point ranging from substantially the axially outermost point of the bead core to a location about 2.0 inches (50.8 mm) radially outward of the bead core as measured along the turnup portion of the single carcass ply.
